(19) United States
(12) Patent Application Publication
(10) Pub. No.: US 2003/0129501 A1
(43) Pub. Date: Jul. 10, 2003

(54) Fabricating artificial crystalline structures

(76) Inventors: Mischa Megens, 's-Hertogenbosch (NL); Pierre Wiltzius, Millington, NJ (US); Shu Yang, North Plainfield, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/040,017

(22) Filed: Jan. 4, 2002

(51) Int. Cl. G03H 1/04

(52) U.S. Cl. 430/1; 430/2; 430/290; 430/330; 359/3; 359/10

(57) ABSTRACT

A method that includes exposing a photo-sensitive medium to an optical intensity pattern and then heating the exposed medium. The exposing is performed under conditions that inhibit or prevent the optical intensity pattern from producing refractive index changes in the medium. The heating stimulates a pattern of refractive index changes that is responsive to the optical intensity pattern during the exposing step.

### BACKGROUND OF THE INVENTION

1. Field of the Invention

This invention relates to artificially constructing crystalline structures.

2. Discussion of the Related Art

The prior art includes various methods for artificially fabricating 2-dimensional (2D) and 3-dimensional (3D) crystalline structures. The various methods are based on colloidal sedimentation, self-assembly of block copolymers, lithography combined with log-stacking, pointwise writing, and multi-beam optical interference. The structures fabricated by these methods have been useful in the production of photonic bandgap materials.

Multi-beam interference offers advantages over the other methods of artificially fabricating crystalline structures. Among the advantages of multi-beam interference methods are an ability to select the structure's lattice constants, an ability to produce defect-free structures, and the availability of inexpensive commercial implementations.

Nevertheless, fabrication methods based multi-beam interference produce a type structure growth that interferes with the fabrication of 3D crystalline structures. The growth occurs simultaneously throughout the volume of medium, e.g., via photo-initiated polymerization, rather than occurring along interface as in classical crystal growth. The volume-based growth produces a refractive index pattern that diffracts the light beams stimulating the growth. Thus, the growing crystalline structure interferes with continuation of the growth by partially washing out the beams that produce the growth.

To reduce such washout, some fabrication methods have used a flashed multi-beam exposure to grow 3D crystalline structures. For a short enough flash, the structure's growth does not proceed enough to significantly diffract the light beams producing continued growth, i.e., washout is low. While such multi-beam interference methods reduce washout, using a flash to produce the structure's growth is inconvenient and limits the upper density of the final crystalline structure.

### SUMMARY OF THE INVENTION

Various embodiments use two-step methods to grow crystalline structures. In the first step, an optical intensity pattern exposes a photo-sensitive medium without causing significant changes to the medium's refractive index. In the second step, a heat treatment initiates a chemical reaction that changes the refractive index of the medium in regions that were exposed by the optical intensity pattern. Since the first step does not initiate the chemical reaction that produces refractive index changes, growth of a crystalline pattern in the medium is not washed out during the exposure step.

In one aspect, the invention features a method that includes exposing a photo-sensitive medium to an optical intensity pattern and then heating the exposed medium. The exposing is performed under conditions that inhibit or prevent the optical intensity pattern from producing refractive index changes in the medium. The heating stimulates a pattern of refractive index changes that is responsive to the optical intensity pattern during the exposing step.

In another aspect, the invention features a photo-sensitive material that includes a medium capable of undergoing a refractive index changing chemical reaction. The medium including photo-sensitizer and neutralizer molecules dispersed therein. The photo-sensitizer molecules stimulate photo-chemical reactions in response to being exposed to light. Products of the photo-chemical reactions are able to stimulate the refractive index changing chemical reaction. The neutralizer molecules are able to neutralize a portion of the products of the photo-chemical reactions.

In another aspect, the invention features a method for making crystalline structures. The method includes providing a medium with photo-sensitizer molecules dispersed therein and exposing the medium to an optical interference pattern that is produced by combining a plurality of mutually coherent beams of light of a particular wavelength. The photo-sensitizer molecules catalyze photo-chemical reactions in response to being activated by the light. Products of the photo-chemical reactions are able to stimulate refractive index changes in the medium. The exposing step is done at a temperature that inhibits or prevents the products from causing the refractive index changes.

### BRIEF DESCRIPTION OF THE DRAWINGS

FIG. 1 is a flowchart illustrating a method of artificially fabricating a 2D or 3D crystalline structure;

FIG. 2A is an oblique view of setup for exposing a photo-sensitive medium used in the method of FIG. 1;

FIG. 2B is an enlarged cross-sectional view that illustrates the positioning of prisms and substrate used in the setup of FIG. 1;

FIG. 3 shows an epoxide-based oligomer of exemplary photo-sensitive starting media for the method of FIG. 1;

FIG. 4A-4C show photo-sensitizer molecules of exemplary photo-sensitive starting media of FIG. 3;

FIGS. 5A-5B show initiator molecules of exemplary photo-sensitive starting medium of FIG. 3;

FIG. 6 shows light-initiated reactions for an exemplary starting medium used in the method of FIG. 1;

FIG. 7 shows reactions initiated by heating the exemplary starting medium of FIG. 6;

FIG. 8 is a flowchart illustrating a method of fabricating crystalline structures with selected defects;

FIG. 9 is a flowchart illustrating a method of fabricating photonic bandgap devices from templates produced by the methods of FIGS. 1 and 8;

FIG. 10 shows a closed crystalline structure produced by the method of FIG. 1; and

FIGS. 11A-11B show two open crystalline structures produced by adding neutralizer molecules to the photo-sensitive starting medium of the method of FIG. 1.

### DETAILED DESCRIPTION OF ILLUSTRATIVE EMBODIMENTS

Herein, 2D and 3D crystalline structures refer to structures with non-trivial periodicities along two and three directions, respectively.

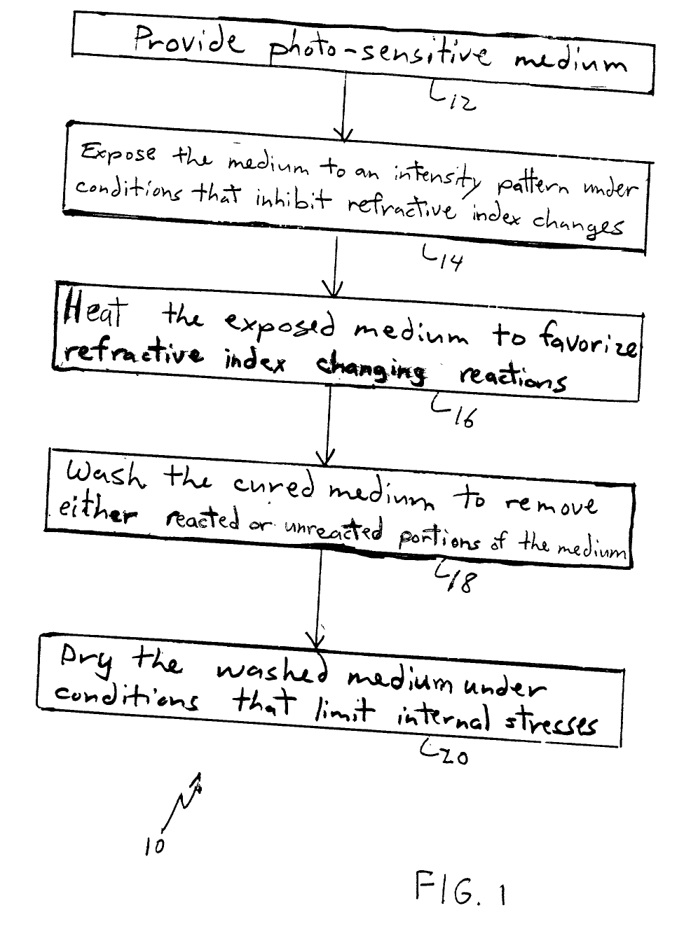

FIG. 1 illustrates a method 10 for making artificial 2D or 3D crystalline structures. The method 10 includes providing a 3D volume of a photo-sensitive starting medium (step 12). The photo-sensitive starting medium includes photo-sensitizer molecules and either oligomers or polymers. Both the photo-sensitizer molecules and the oligomers or polymers are uniformly dispersed in a solvent.

The photo-sensitizer molecules initiate chemical reactions in response to being exposed to appropriate wavelengths of light. The photo-chemical reactions generate products that are able to stimulate other chemical reactions that change the index of the starting medium. Exemplary of these other chemical reactions are polymerization of the oligomers, deprotection of units of polymers, and crosslinking of functional groups of polymers.

A suitable 3D volume of the photo-sensitive starting medium is prepared by spin coating or casting a film of the medium on a rigid transparent substrate. After the spin coating or casting, the film is prebaked to evaporate out the solvent.

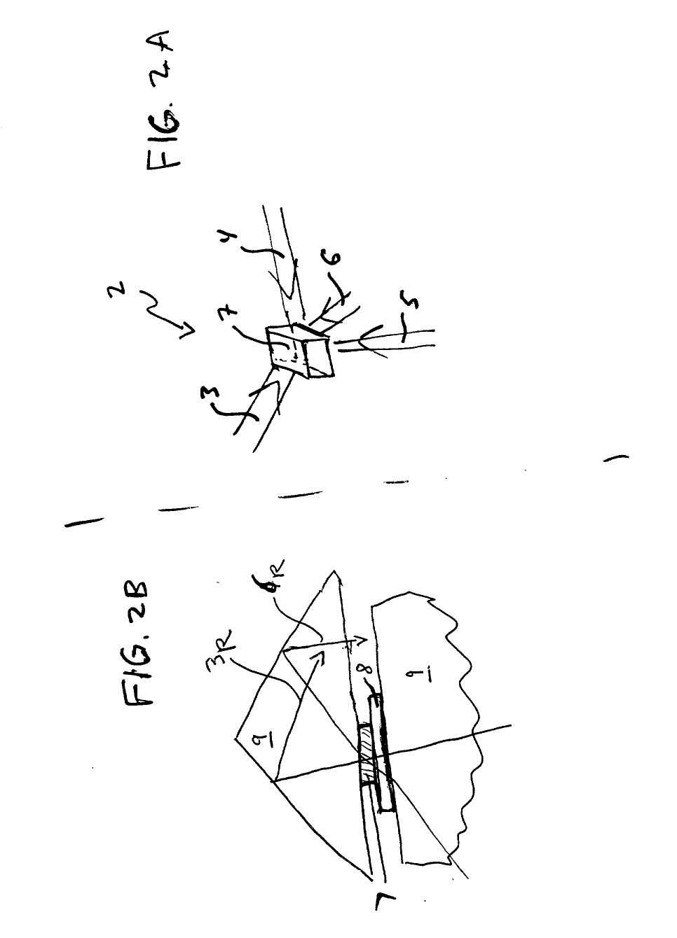

The method 10 also includes exposing the whole 3D volume of photo-sensitive starting medium to an optical intensity pattern under conditions that inhibit or prevent the intensity pattern from causing refractive index changes to the medium (step 14). FIG. 2A shows a setup 2 for producing the optical intensity pattern with multiple laser light beams 3, 4, 5, 6. The beams 3-6 are mutually coherent and thus, coherently interfere to produce the optical intensity pattern. The four mutually coherent beams 3-6 interfere to produce a pattern with periodic intensity variations in three independent directions. Exemplary beams 3-6 pass through (1,1,5), (1,5,1), (5,1,1), and (3,3,3) directions in a coordinate system where the photo-sensitive medium 7 is located at the coordinate origin (0,0,0).

Referring to FIG. 2B, to insure that the 3D optical intensity pattern is defined by the four beams 3-6, the photo-sensitive medium 7 and supporting substrate 8 are optionally disposed between thick transparent prisms 9, e.g., glass prisms. The prisms 9 are shaped and positioned to stop reflected light rays 3_{R}-6_{R} from returning to the photo-sensitive starting medium 7 and thereby further exposing the medium 7.

Referring to FIGS. 1 and 2A, the wavelength of the light is selected so that the optical intensity pattern activates photo-sensitizer molecules dispersed in the photo-sensitive starting medium 7. The activated photo-sensitizer molecules initiate sequences of photo-chemical reactions. The products of the photo-chemical reactions diffuse slowly in the medium 7. Thus, after exposure step 14, the reaction products are distributed with a density pattern that tracks the optical intensity pattern used to expose the medium 7.

The density pattern of reaction products continues to track the original light intensity pattern for a considerably time period. During this time period, the method 10 includes heating the exposed medium under conditions that favor chemical reactions that change the refractive index of the medium 7, e.g., polymerization of a portion of the oligomers distributed therein (step 16). Exemplary heating steps involve baking the exposed medium at a temperature higher than a temperature at which the medium 7 makes a transition from a glass-like phase to a rubber-like phase. In the higher temperature rubber-like phase, rotational motions by oligomers or polymers of the medium 7 and by groups of said oligomers or polymers increase significantly. This increased motion produces larger free volumes in the medium 7 and allow reactions that produce refractive index changes to proceed.

In addition, the high temperatures and larger free volumes increase the diffusivity of reaction products, which were earlier produced when the sensitizer molecules were exposed to the optical intensity pattern. The increased diffusivity also enables the reaction products to catalyze or stimulate reactions that change the refractive index of the medium, e.g., polymerization or crosslinking reactions. Thus, the distribution of products from the stimulated or catalyzed reactions, e.g., polymerized oligomers, also tracks the original optical intensity pattern that exposed the medium. These products of the catalyzed or stimulated reactions change the refractive index of the medium in regions where the products occur. Thus, heating step 16 produces a refractive index pattern with a 2D or 3D crystalline symmetry in the exposed medium.

The method 10 also includes washing the heated medium with a solvent that dissolves either reacted or unreacted portions of the medium, e.g., to dissolve away the unpolymerized oligomers (step 18). After the washing, an interconnected crystalline structure remains, e.g., a structure formed of polymerized oligomers in which the stimulated or catalyzed reactions cause oligomers to polymerize. The interconnected structure has the nontrivial 2D or 3D periodicity of the original light intensity pattern used in exposure step 14.

The washing step 18 does not remove solvent from within the crystalline structure. To produce a crystalline material that is free of solvent, the washed medium is dried (step 20). The drying conditions are selected to limit surface-tension stresses that the liquid solvent applies on the crystalline structure of polymerized oligomers during drying. Such surface-tension stresses could, otherwise, destroy the fragile crystalline structure formed of polymerized oligomers.

One drying method for limiting such internal stresses during drying takes advantage of critical properties of liquids. In this method, the absorbed solvent is first replacing by liquid carbon dioxide. Replacing the solvent involves placing the washed medium in liquid carbon dioxide. The liquid carbon dioxide diffuses into the structure thereby replacing absorbed solvent without drying the crystalline structure. After replacing the solvent with liquid carbon dioxide, the pressure and temperature are raised to their values at carbon dioxide's critical point, and the carbon dioxide is allowed to diffuse out of the crystalline structure. Since carbon dioxide has no surface tension at its critical point, the diffusion of carbon dioxide out of the interconnected crystalline structure does not produce internal surface-tension stresses.

An important aspect of method 10 is that oligomers do not polymerize during exposure step 14. During the exposure step 14, the photo-sensitive starting medium is maintained at physical conditions that prevent or inhibit or prevent significant progress of reactions that change the refractive index of the photo-sensitive starting medium 7. For example, polymerization of oligomers does not significantly proceed in exemplary photo-sensitive starting medium 7 that contain dispersed oligomers. Polymerization is inhibited or prevented, because the temperature is maintained below the transition temperature for the rubber-like phase of the photo-sensitive starting medium. Below the transition temperature, dispersed oligomers and groups of oligomers are unable to perform rotational motions that are typically needed for polymerization. Maintaining the photo-sensitive starting medium 7 below the transition temperature blocks the reaction sequences initiated by activated sensitizer molecules prior to actual polymerization of oligomers.

If such reactions occurred during exposure step 14, the photo-sensitive medium's would develop a refractive index pattern that diffracted the exposing light during a portion of the exposure step 14. Such a refractive index feedback would interfere with controlling formation of the final pattern through the applied optical intensity pattern. By preventing or inhibiting refractive index changing reactions during the exposure step 14 better control is obtainable over the pattern produced in the photo-sensitive medium.

The method 10 for making crystalline structures uses a variety of photo-sensitive starting media 7, i.e., exemplary compositions. Exemplary photo-sensitive starting medium 7 are photoresists that include a non-nucleophilic solvent and uniform density of epoxide oligomers in the solvent. The exemplary starting media also include photo-sensitizer molecules and initiator complexes that are uniformly dispersed in the solvent.

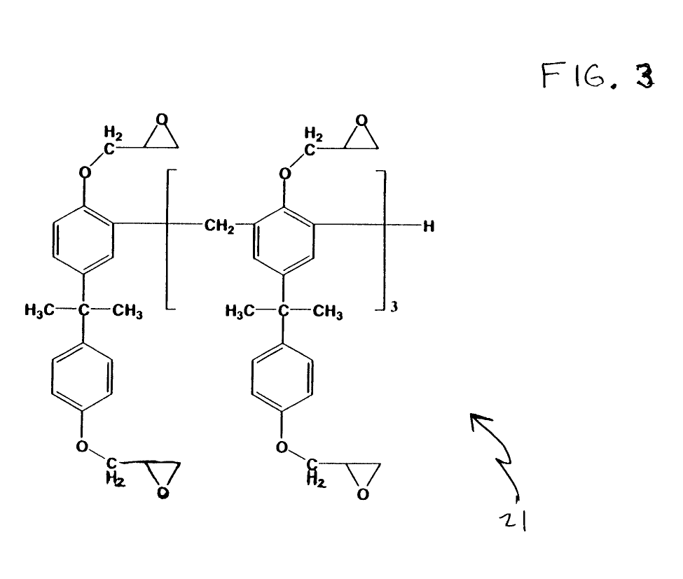

FIG. 3 shows the epoxide oligomer 21 of the exemplary photo-sensitive starting media. A resin of this oligomer is available commercially from Resolution Performance Products, 1600 Smith Street, 24th Floor, P.O. Box 4500, Houston, Tex. 77210-4500 USA, under the product name EPON™ SU-8.

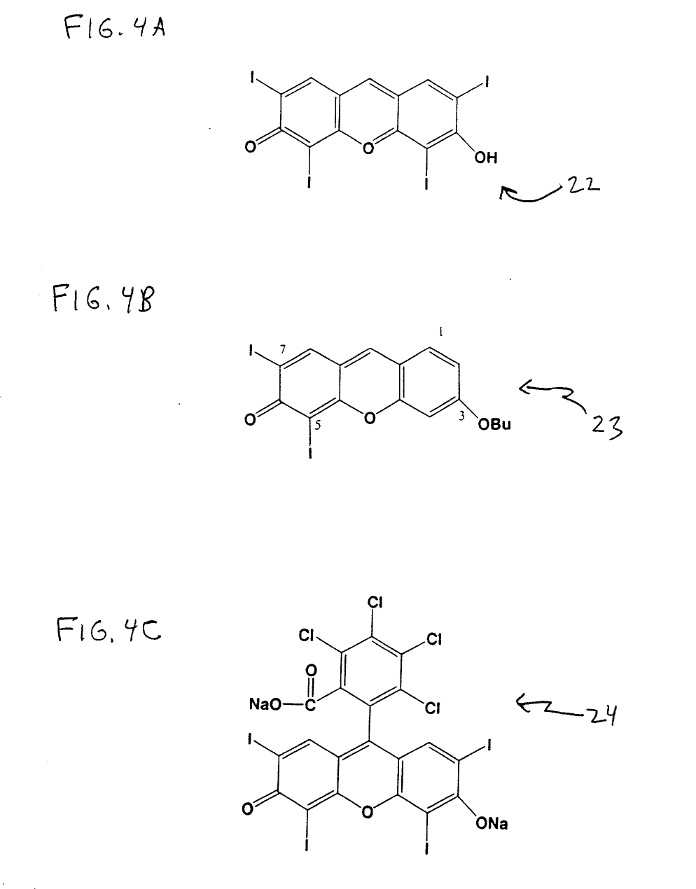

FIGS. 4A-4C show sensitizer molecules 22-24 of various exemplary photo-sensitive starting media. The sensitizer molecules 22-24 are a dyes that are activated by visible light. The dyes 22, 23 are optimally activated by light having wavelengths of about 535 nanometers (nm) and 470 nm, respectively. These dyes 22, 23 are available from Spectra Group Limited, Inc., 1722 Indian Wood Circle, Suite H Maumee, Ohio 43537 USA, under respective product names HNu-535 and HNu-470. The dye 24 is optimally activated by light having a wavelength of about 560 nm and is known in the art as Rose Bengal and is available from Aldrich Company, P.O. Box 2060, Milwaukee, Wis. 53201 USA.

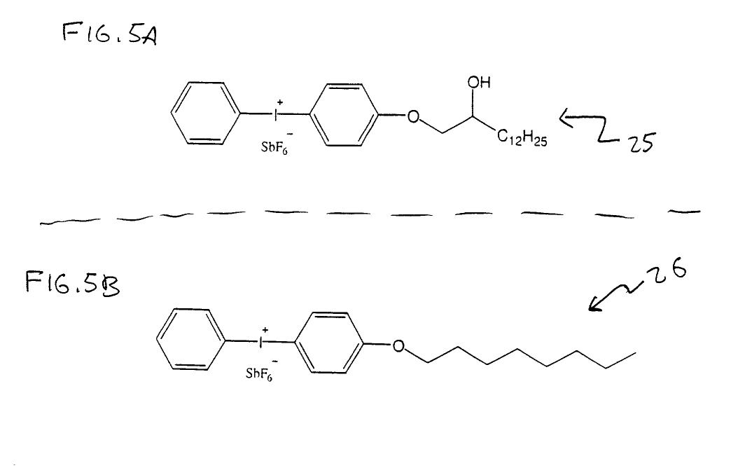

FIGS. 5A-5B show ionic initiator complexes 25-26 of various exemplary photo-sensitive starting media. These initiator complexes 25-26 are photoacid generators (PAGs). The ionic initiator complex 25 is available from Sartomer Inc., Oaklands Coporate Center, 502 Thomas Jones Way Exton, Pa. 19341 USA, under the product name SarCat® SR1012. The ionic initiator complex 26 is available from UCB Chemicals Corp., 2000 Lake Park Drive, Smyrna (Atlanta), Ga. 30080 USA, under the product name OPPI.

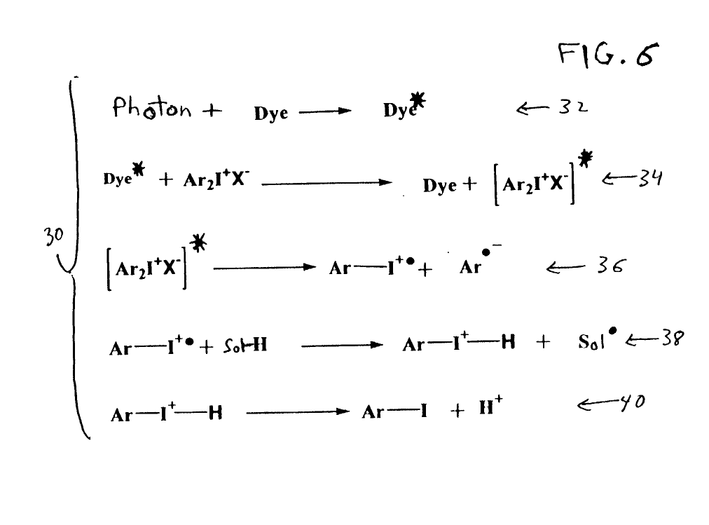

FIG. 6 shows photo-reactions 30 that are initiated by exposing an exemplary photo-sensitive starting medium to light with a wavelength of 514 nm. The exemplary photo-sensitive starting medium includes the visible dye molecules 22 shown in FIG. 4A and the ionic initiator complexes 25 shown in FIG. 5A.

The reactions start with the production of an activated molecule of dye* by an absorption of a photon of 514 nm light by the molecule of dye (reaction 32). The activated molecule of dye* transfers energy to an ionic initiator complex, Ar₂I⁺X⁻, to produce an activated ionic initiator complex, Ar₂I⁺X^{-*} (reaction 34). The activated ionic initiator, Ar₂I⁺X^{-*}, subsequently decays to produce a pair of free radicals, i.e., ArI⁺X^{●} and Ar^{-●}(reaction 36). One of the free radicals ArI⁺X^{-●} reacts with a hydrogen atom of a solvent molecule, i.e., Sol-H, to produce a complex ArI⁺XH and a free radical, Sol^{●} (reaction 38). The complex ArI⁺XH is unstable and decays to produce a free hydrogen cation, H⁺, i.e., acid production (reaction 40). In the sequence of photo-reactions 30, equilibria favor rapid production H⁺-ions.

During exposure step 14 of FIG. 1, the temperature of the medium is kept low to prevent and inhibit polymerization reactions between oligomer molecules of FIG. 3. Temperatures lower than the glass-like to rubber-like transition temperature of the medium, i.e., 65° C., are low enough. Below the transition temperature, there is little free volume for oligomers to perform rotational movements that are needed for polymerization. At such temperatures, the H⁺-ions produced by the photo-reactions 30 of FIG. 6 are also prevented from diffusing. The result is at these temperatures the H⁺-ions do not significantly catalyze polymerization of the oligomers and have a distribution that tracks the optical intensity pattern used to expose the medium.

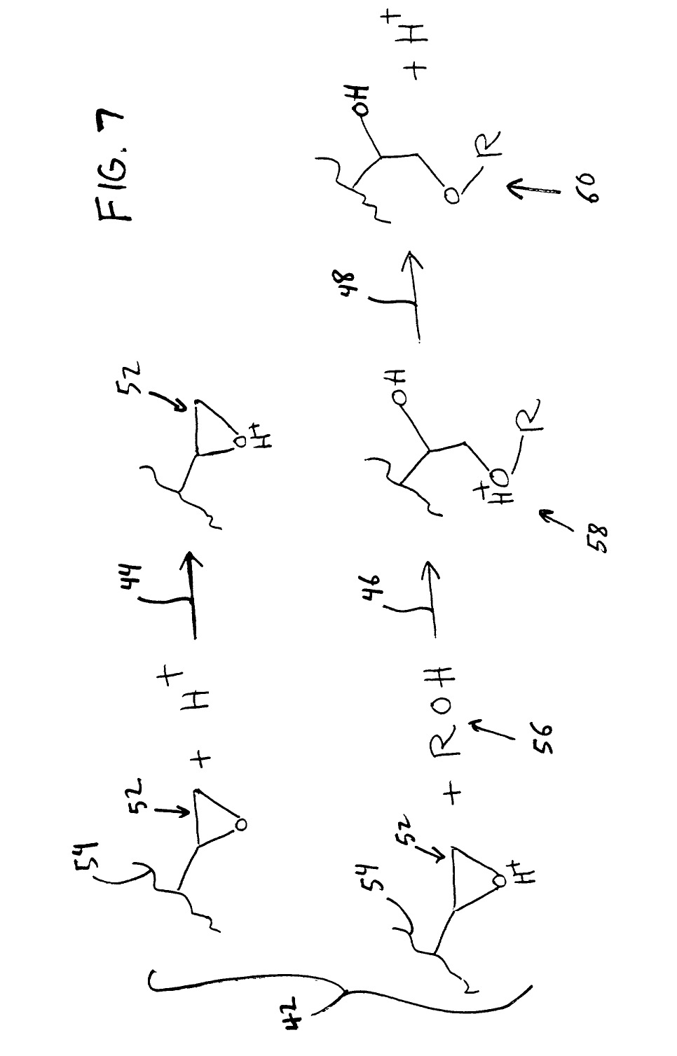

FIG. 7 shows a sequence of polymerization reactions 42, which are catalyzed by H⁺-ions, in photo-sensitive starting media that includes the epoxide oligomers 21 shown in FIG. 3. The polymerization reactions are favored under conditions present during heating step 16 of method 10, shown in FIG. 1.

A cycle of the sequence of polymerization reactions 42 starts when an H⁺-ion attacks the epoxide ring 52 of an oligomer 54 (reaction 44). After being protonated, the oxygen of the epoxide ring 52 undergoes nucleophilic attack by a hydroxide moiety of a second molecule 56, i.e., R—OH (reaction 46). Exemplary R—OH molecules are trace alcohol or water molecules absorbed in the medium. The nucleophilic attack produces a complex 58 in which the R-moiety from the second molecule is chemically bonded to the oxygen of the original epoxide ring 52. Subsequently, the complex 58 decomposes to regenerate a free H⁺-ion and a molecule 60 with a hydroxide moiety, i.e., an alcohol (reaction 48).

The sequence of polymerization reactions 42 generates molecule 60, which has a hydroxide moiety, and regenerates a H⁺-ion. These two molecular entities are available for the next cycle of the sequence of reactions 42. In the next cycle, the R—OH molecule is the molecule 60 produced by the previous cycle. A single H⁺-ion is capable of catalyzing many cycles of the sequence of reactions 42. Each cycle adds an additional oligomer to molecule 60 from the last cycle thereby producing a growing polymer.

In each cycle, the protonated epoxy ring 52 of an oligomer 54 must properly align with the growing polymer, and the acid, H⁺, must be close to the epoxy ring for reactions 46 and 44 to proceed. To produce the alignment, chain segments of the oligomers need great freedom to perform rotational motions. Such rotational motions are possible when the photo-sensitive starting medium is in a rubber-like phase, i.e., when the temperature is above the transition temperature to such a phase. In the rubber-like phase, there is more free volume in the medium, and the acid cations, i.e., H⁺-ions, are able to move close to the epoxy ring. Thus, polymerization only proceeds significantly above the glass-rubber transition temperature.

Various embodiments use crystalline structures produced by method 10 of FIG. 1 to construct optical devices.

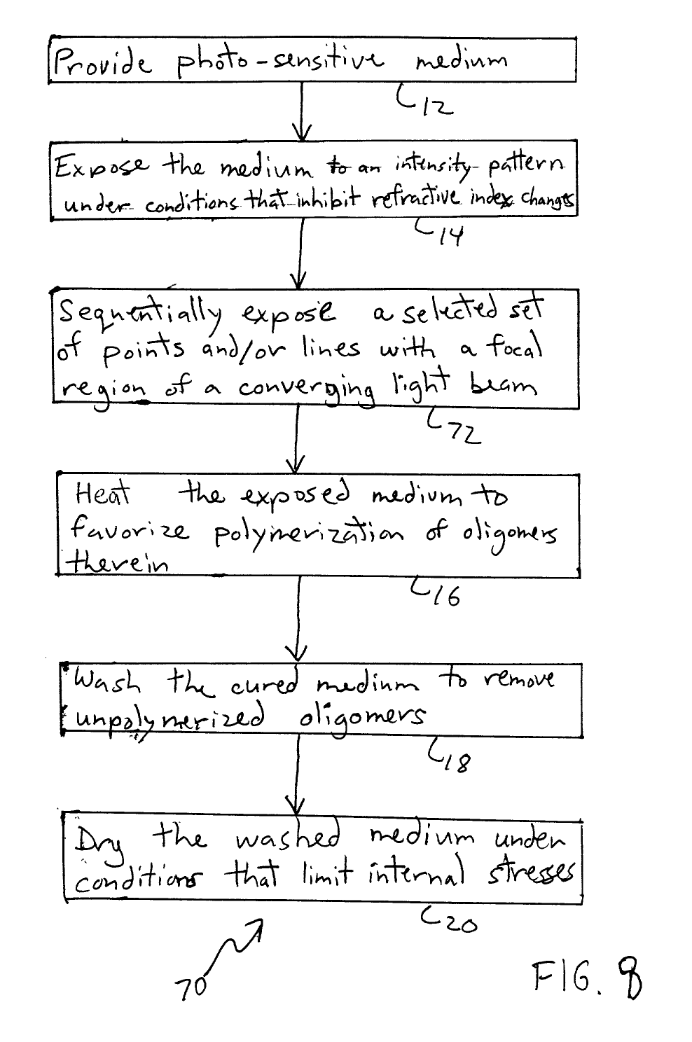

FIG. 8 illustrates a method 70 for making a 3D crystalline structure with one or more desired defects. The method 70 includes providing and exposing a photo-sensitive starting medium according to steps 12 and 14 of method 10. The method 70 also includes using a focal region of a converging light beam to sequential expose one or more desired points and/or lines in the photo-sensitive medium (step 72). The light of the converging beam has a longer wavelength than the light used in step 14. The longer wavelength enables the converging light beam to only activate photo-sensitizer molecules through two-photon or higher multiple-photon processes. Such processes only occur at significant rates in the high intensity focal region of the converging light beam. For this reason, the converging beam functions as a writing instrument that enables exposing small points and/or fine lines in the photo-sensitive medium.

The method 70 also includes heating the exposed medium according to step 16 of method 10. The heating step 16 now polymerizes portions of the photo-sensitive media that were exposed during either step 14 or step 72. The method 70 also includes washing and drying the heated medium according to steps 18 and 20 of method 10. After the drying step, a crystalline structure with the desired one or more defects is obtained.

In exemplary devices produced by method 70, the defects are either optical channels for transporting optical signals through the crystalline structure or point-defects for providing couplings between various optical channels.

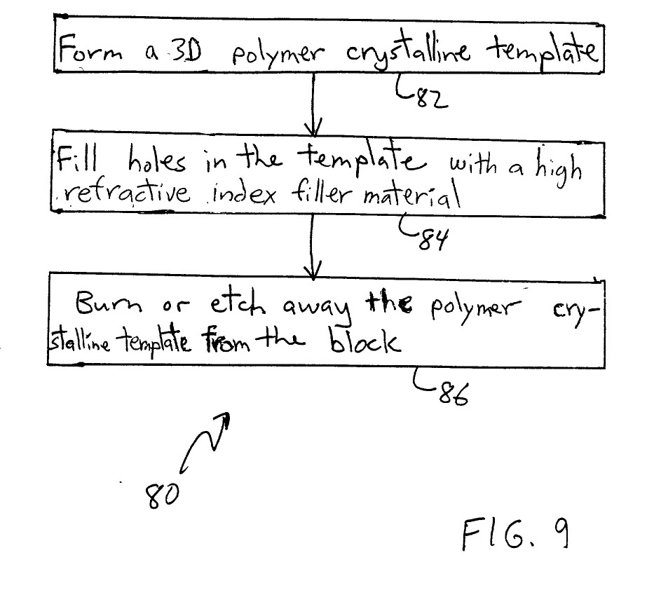

FIG. 9 illustrates a method 80 of making a 3D photonic bandgap material or device. The method 80 includes forming an artificial crystalline template according to method 10 of FIG. 1 or method 70 of FIG. 8 (step 82). The template is a 3D polymerized crystalline structure that includes a selected set of point and/or line defects. The method 80 includes filling holes of the template with a high refractive index filler material to produce a solid block (step 84). The filler materials typically have refractive indexes of 2.0 or larger. An exemplary filler material is TiO₂. The method 80 also includes burning or plasma etching the polymerized oligomer from the solid block to produce the final photonic bandgap material or device (step 86). The final photonic bandgap material or device has a reverse structure of the template.

Referring again to FIG. 1, method 10 interferes three or four light beams to produce the optical intensity pattern used to expose the photo-sensitive starting medium. The three or four light beams are not all coplanar (see, e.g., FIG. 2A). Thus, the three or four light beams do not have completely coplanar polarizations. Due to the absence of coplanar polarizations, the beams produce patterns with nonzero constant background optical intensities when combined. If a photo-sensitive medium is exposed with such a combination of light beams, the constant background optical intensity will produce a constant background polymerization structure after heating. Constant background polymerization structures are typically undesirable, because they are closed crystalline structures.

FIG. 10 shows an exemplary closed crystalline structure 90. The closed structure 90 is not useful as a template for making photonic bandgap materials, because voids 91 in the closed structure 90 are not interconnected. Thus, the closed structure 90 would not allow a filler material to penetrate throughout the structure 90, if the closed structure 90 was used as a template for making a photonic bandgap material.

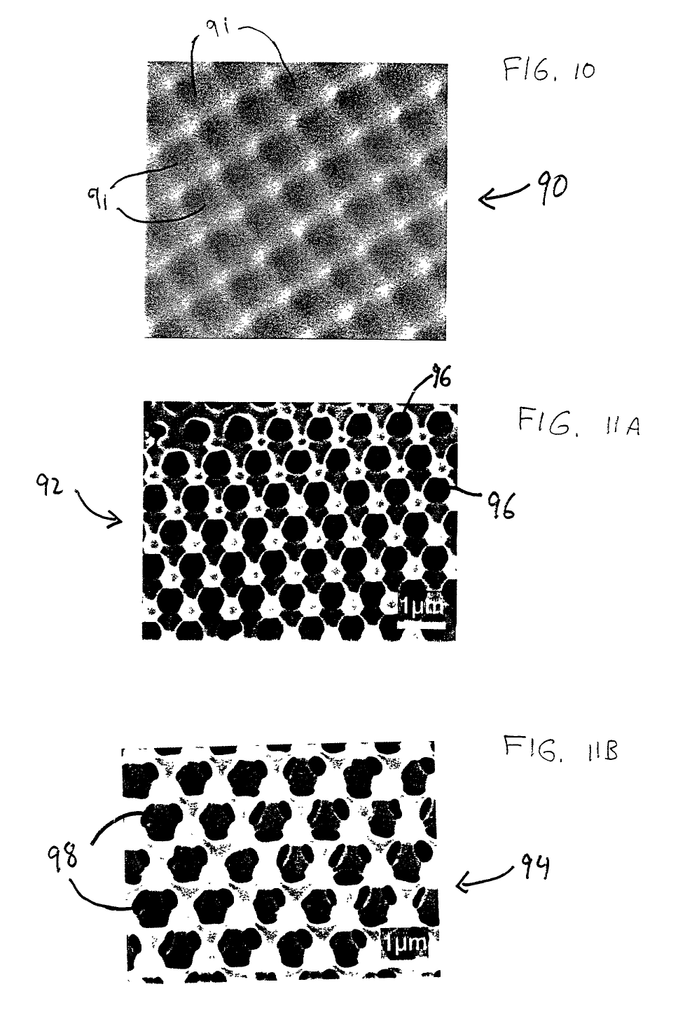

Referring again to FIG. 9, templates used in method 80 are preferably open crystalline structures. FIGS. 11A-11B show exemplary open crystalline structures 92, 94. In the open crystalline structures 92, 94, voids 96, 98 thread through and interconnect the entire structures 92, 94. The connecting voids 96, 98 enable filling material such as TiO₂ to pass through the entire crystalline structure 92, 94. Thus, the open crystalline structures 92, 94 can act as 3D templates for producing reverse structures according to the method 80.

The nonzero background polymer density that produced closed crystalline structure 90 is avoidable. To avoid the background density, an appropriate concentration of neutralizer molecules is dispersed in the photo-sensitive starting medium of method 10. The initial concentration of the neutralizer is selected to neutralize the background density of polymerization catalyst that will be produced by the multi-beam interference pattern used to expose the photo-sensitive starting medium without completely stopping polymerization reaction or other refractive index changing reaction. If the catalyst for the refractive index changing reaction is an acid as for the sequence of polymerization reactions 42 of FIG. 7 an appropriate neutralizer is a base such as triethyl amine or N,N,2,4,6-pentamethylaniline.

The open crystalline structures 92, 94 shown in FIGS. 11A and 11B were made by adding initial background concentrations of base to the photo-sensitive starting medium used to make the structures 92, 94. The background concentrations of base neutralized background concentrations of H⁺-ions produced during exposure step 14 thereby eliminating constant background polymer densities. Eliminating these background polymer densities caused the final crystalline structures 92, 94 to have voids 96, 98, which thread entirely through the crystalline structures 92, 94.

Other embodiments will be apparent to those of skill in the art from the detailed description, figures, and claims.

What is claimed is:

1. A method, comprising:
exposing a photo-sensitive medium to an optical intensity pattern while the medium is maintained in a condition that inhibits or prevents the optical intensity pattern from producing refractive index changes in the medium; and
then, heating the exposed medium to stimulate a pattern of refractive index changes that is responsive to the optical intensity pattern during the exposing.

2. The method of claim 1, wherein the condition includes that a temperature of the medium is lower than a temperature of the medium during the heating.

3. The method of claim 1, further comprising:
exposing one or more points or lines in the medium with light that causes photo-chemical reactions in the medium via multiple-photon absorption events.

4. The method of claim 1, wherein the heating produces the pattern of refractive index changes by causing a chemical reaction selected from the group consisting of polymerization of oligomers, stimulating deprotection of portions of polymers, and stimulating crosslinking of polymers.

5. The method of claim 1, wherein the medium includes a concentration of molecules that are able to neutralize photo-chemical reaction products produced by the exposing, the products being able to stimulate the chemical reaction the produces the pattern of refractive index changes.

6. The method of claim 1, wherein the optical intensity pattern is produced by interfering at least three mutually coherent light beams.

7. The method of claim 6, wherein the pattern of refractive index changes tracks the optical intensity pattern.

8. The method of claim 6, wherein the heating causes refractive index changing reactions in regions of the medium where the exposing activated photo-sensitizer molecules dispersed in the medium.

9. The method of claim 6, wherein the heating includes heating the medium to a temperature of a rubber-like phase.

10. The method of claim 6, wherein the heating produces a pattern of refractive index changes that is periodic and non-constant in three independent directions.

11. A photo-sensitive composition, comprising:
a medium capable of undergoing a refractive index changing chemical reaction, the medium further comprising:
photo-sensitizer molecules dispersed in the medium, the photo-sensitizer molecules to stimulate photo-chemical reactions in response to being exposed to light, products of the photo-chemical reactions being able to stimulate the refractive index changing chemical reaction; and
neutralizer molecules dispersed in the medium, the neutralizer molecules being able to neutralize a portion of the products of the photo-chemical reactions.

12. The composition of claim 11, wherein one of the products and neutralizer molecules is an acid and the other of the products and the neutralizer molecules is a base.

13. The composition of claim 11, wherein the photoresist has a rubber-like phase, the index changing reactions being inhibited or prevented at temperatures below a transition temperature for the phase.

14. A method for making crystalline structures and devices, comprising:
providing a medium with photo-sensitizer molecules dispersed therein, the photo-sensitizer molecules to catalyze photo-chemical reactions in response to being activated by light of a wavelength, products of the photo-chemical reactions being able to stimulate refractive index changes in the medium; and
exposing the medium to an optical interference pattern that is produced by combining a plurality of mutually coherent beams of light of the wavelength, the exposing being done at a temperature that inhibits or prevents the products of the photo-chemical reactions from causing the refractive index changes.

15. The method of claim 14, wherein the providing a medium includes providing a medium with a concentration of molecules to neutralize a portion of the products, the neutralized portion of the products being unable to cause refractive index changes in the medium.

16. The method of claim 14, further comprising:
heating the exposed medium to stimulate the products to cause refractive index changes in the medium.

17. The method of claim 16, wherein the photo-sensitizer molecules are visible dye molecules and the products cause polymerization, deprotection, or crosslinking reactions in the medium in response to the heating.

18. The method of claim 16, wherein the heating produces an interconnected open polymerized structure.
